(19) United States
(12) Patent Application Publication
(10) Pub. No.: US 2007/0290410 A1
(43) Pub. Date: Dec. 20, 2007

(54) Fire retardant polymer nanocomposites for laser sintering

(76) Inventors: Joseph H. Koo, Austin, TX (US); Louis A. Pilato, Bound Brook, NJ (US); Gerhardt E. Wissler, Fort Worth, TX (US)

Correspondence Address: M. A. Ervin & Associates, 8202 Talbot Cove, Austin, TX, 78746, US

(21) Appl. No.: 11/193,143

(22) Filed: Jul. 29, 2005

(51) Int. Cl. B29C 35/08; B29C 41/02

(52) U.S. Cl. 264/497; 425/174.4; 425/375

(57) ABSTRACT

A method and apparatus for forming three dimensional flame retardant objects by laser sintering that includes homogeneously combining, by an extrusion process, certain polymer materials with nanoparticles and using the resultant powder in a laser sintering device to produce freeform parts.

### BACKGROUND OF THE INVENTION

This invention is in the field of solid freeform fabrication (SFF), and is more specifically directed to the fabrication of three-dimensional objects by selective laser sintering.

Solid freeform fabrication (SFF) generally refers to the manufacture of articles directly from computer-aided-design (CAD) databases in an automated fashion, rather than by conventional machining of prototype articles according to engineering drawings. SFF has been embraced as a preferred tool for not only product development but in many cases, “just-in-time manufacturing.” The use of recently developed additive layered build fabrication methods of SFF, particularly selective laser sintering (SLS) have the potential to facilitate true flexible manufacturing of small batchs of parts “on-demand” while avoiding product-line tooling, under utilization of skilled labor and the need to maintain high overhead facilities costs. The field of solid freeform fabrication of parts has, in recent years, made significant improvements in providing high strength, high density parts for use in the design and pilot production of many useful articles.

By way of background, an example of a freeform fabrication technology is selective laser sintering in which articles are produced from a laser-fusible powder in layerwise fashion. According to this process, a thin layer of powder is dispensed and then fused, melted, or sintered, by laser energy that is directed to those portions of the powder corresponding to a cross-section of the article. Conventional selective laser sintering systems position the laser beam by way of galvanometer-driven mirrors that deflect the laser beam. The deflection of the laser beam is controlled, in combination with modulation of the laser itself, to direct laser energy to those locations of the fusible powder layer corresponding to the cross-section of the article to be formed in that layer. The computer based control system is programmed with information indicative of the desired boundaries of a plurality of cross sections of the part to be produced. After the selective fusing of powder in a given layer, an additional layer of powder is then dispensed, and the process repeated, with fused portions of later layers fusing to fused portions of previous layers (as appropriate for the article), until the article is complete.

Detailed description of the selective laser sintering technology may be found in U.S. Pat. No. 4,863,538, U.S. Pat. No. 5,132,143, and U.S. Pat. No. 4,944,817, all assigned to Board of Regents, The University of Texas System, and in U.S. Pat. No. 4,247,508, Housholder, all incorporated herein by this reference.

The selective laser sintering technology has enabled the direct manufacture of three-dimensional articles of high resolution and dimensional accuracy from a variety of materials including polystyrene, some nylons, other plastics, and composite materials such as polymer coated metals and ceramics. Polystyrene parts may be used in the generation of tooling by way of the well-known “lost wax” process. In addition, selective laser sintering may be used for the direct fabrication of molds from a CAD database representation of the object to be molded in the fabricated molds; in this case, computer operations will “invert” the CAD database representation of the object to be formed, to directly form the negative molds from the powder.

Materials that are commonly used to fabricate polymeric SLS parts are high strength thermoplastics such as nylon (polyamide) 11 (PA11) and nylon (polyamide) 12 (PA12) as well as polystyrene. All of these polymeric materials lack flame retardance. This is a critical safety requirement especially for the manufacture of finished products that invariably require some flame retardance. Methods to flame retard or modify flammable thermoplastic materials to flame retardant products consists of the introduction of flame-retardant additives such as inorganic metal oxides/hydroxides (aluminum trihydrate, magnesium hydroxide) or halogens with or without phosphorous and nitrogen containing materials. Large amounts of metal oxides (>30%) are necessary to flame retard thermoplastics and in many cases compromises some mechanical properties of the thermoplastic such as reduced toughness, melt flow, etc. Similarly use of halogens and/or phosphorous, nitrogen compounds also involves the addition of large amounts of additive(s) resulting in the release of smoke and toxic emissions when the modified thermoplastic is subjected to fire conditions.

Thus there is an unmet need to address the lack of flame retardance of the polymeric materials used in laser sintering. It is important to note that the number of materials that perform effectively in selective laser sintering is limited. Materials that resolidify or recrystallize quickly after melting tend to exhibit an in-build curl that results in unacceptable warpage. Some materials, however, resolidify slowly enough at the part bed temperature (i.e., the driving force for crystallization is small enough near the melting point) that the parts remain in the supercooled liquid state for a significant amount of time during the part building process. Since liquids do not support stresses, no in-build curl is observed as long as the part is not cooled sufficiently to induce more rapid recrystallization. U.S. Pat. No. 5,648,450 (Dickens, et. al.) describes this aspect of semi-crystalline materials that work well in laser sintering. Materials such as nylon (polyamide) 11 (PA11) and nylon (polyamide) 12 (PA12), polybutylene terephthalate; polypropylene; and polyacetal work effectively in laser sintering because they recrystallize sufficiently slowly in the selective laser sintering process to eliminate any in-build curl. This type of crystalline response is sensitive however to how the polymer was manufactured and can be lost if the polymer is taken through significant melt-recrystallization cycles. Thus any treatment of these types of polymers to address flame retardance is impractical if the treatment destroys the crystalline response desired. Thus there is also a need for a means for addressing flame retardance in SLS materials that does not destroy the crystallinity characteristics that make for effective SLS build performance.

One promising approach to addressing flame retardance in polymers is the proper addition of selected nanoparticles to polymers.. The reinforcement of polymers using fillers, whether inorganic or organic, is common in the production of modern plastics. Polymeric nanocomposites (PNCs) (or polymer nanostructured materials) represent a radical alternative to conventional-filled polymers or polymer blends. In contrast to the conventional systems where the reinforcement is on the order of microns, discrete constituents on the order of a few nanometers (˜10,000 times finer than a human hair) exemplify PNCs. Uniform dispersion of these nanoscopically sized filler particles (or nanomaterials) produces ultra-large interfacial area per volume between the nanomaterial and host polymer. This immense internal interfacial area and the nanoscopic dimensions between nanomaterials fundamentally differentiate PNCs from traditional composites and filled plastics. Thus, new combinations of properties derived from the nanoscale structure of PNCs provide opportunities to circumvent traditional performance trade-offs associated with conventional reinforced plastics, epitomizing the promise of nano-engineered materials.

The potential property improvements usually depend on the degree of delamination and dispersion of the nanocomposites into the polymer matrix. An important early development along these lines is the development by Toyota of an improved method for producing nylon 6/clay nanocomposites using an in situ polymerization process that effectively exfoliates the aluminosilicate layers by an easily understood chemical mechanism. Exfoliation is a process wherein packets of nanoclay platelets separate from one another in a plastic matrix. During exfoliation platelets at the outermost region of each packet cleave off, exposing more platelets for separation. Since then, similar chemical strategies have been described for many thermoplastic and thermoset polymers. In the Toyota process sodium montmorillonite is mixed with an a, w-amino acid (e.g., aminolauric acid) in aqueous hydrochloric acid to protonate the aminolauric acid which then can exchange with the sodium counterions; thus, the alkyl units of the resulting organoclay has terminal carboxyl groups. Under appropriate reaction conditions, the carboxyl groups on the organoclay will initiate ring-opening polymerization of caprolactam to form nylon 6 chains ionically bonded to the aluminosilicate platelets. The growth of these chains, driven by the free energy of polymerization, forces the platelets apart until exfoliation is accomplished. This type of approach, while very effective is limited in application and is not available for example for the nylon 11 and nylon 12 polymers useful for laser sintering. Clearly, nanocomposites might be more widely used in applications like laser sintering if they could be formed from existing polymers using more conventional melt processing techniques (extrusion, injection molding, etc.) instead of techniques that require addition of the nanocomposite at the time of polymer synthesis and thus there is a need for an alternate methodology.

### BRIEF SUMMARY OF THE INVENTION

It is therefore an aspect of the present invention to provide a method and apparatus for producing free formed parts by laser sintering that have improved flame retardance to conventionally produced free formed parts.

It is another aspect of the present invention to provide a method for producing free formed parts by laser sintering from polymer nanocomposites in which the nanocomposites are added by conventional techniques to polymers after they have been synthesized.

The goals of the present invention can be achieved with a method of producing a flame resistant part including at least the steps of: depositing a first portion of powder onto a target surface, said first portion of powder comprising a first material and a second material, said second material being nanoparticles; scanning the aim of a directed energy beam over the target surface; sintering a first layer of the first powder portion corresponding to a first cross-sectional region of the part by operating the beam when the aim of the beam is within boundaries defined by said first cross-sectional region; depositing a second portion of powder onto the first sintered layer, said second portion of powder comprising a first material and a second material, said second material being nanoparticles; scanning the aim of a directed energy beam over the first sintered layer; sintering a second layer of the second powder portion corresponding to a second cross-sectional region of the part by operating the beam when the aim of the beam is within boundaries defined by said second cross-sectional region, including the substep of joining the first and second layers during the sintering of the second layer; and depositing successive portions of powder onto the previous sintered layers and sintering each successive portion to produce successive sintered layers joined to a previous sintered layer and a part comprising a plurality of sintered layers.

The goals of the present invention are also met by an apparatus for producing a flame resistant part including at least: a scanning system for selectively emitting a directed energy beam; a structure for providing a target area for producing the part; a powder comprising a first material and a second material, the second material comprising nanoparticles; a spreading mechanism for spreading the powder across the target area; and a control system for deflecting the aim of the energy beam and for modulating the energy beam to selectively sinter within defined boundaries a layer of powder dispensed in the target area, the control system being operable to effect selective sintering of sequential layers of powder within respective defined boundaries to produce a part comprising a plurality of layers sintered together.

### DESCRIPTION OF DRAWINGS

FIG. 1 is a view of a conventional selective laser sintering machine

FIG. 2 is a front view of a conventional selective laser sintering machine showing some of the mechanisms involved.

FIG. 3 is an illustrative view of exfoliation in a polymer nanocomposite system.

FIG. 4 is an illustrative view of a possible mechanism of exfoliation in a shear system such as an extruder.

### DETAILED DESCRIPTION OF THE INVENTION

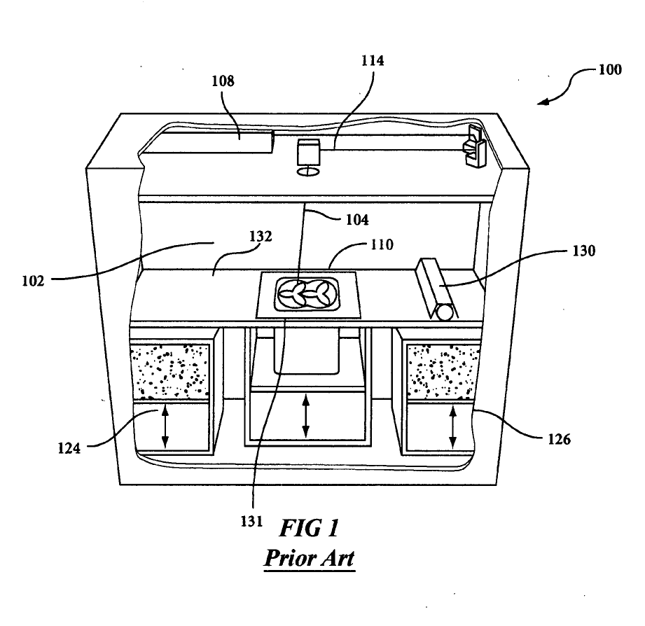

FIG. 1 illustrates, by way of background, a rendering of a conventional selective laser sintering system. FIG. 1 is a rendering shown without doors for clarity. A carbon dioxide laser 108 and its associated scanning system 114 is shown mounted in a unit above a process chamber 102 that includes a powder bed 132, two feed powder cartridges 124, 126, and a leveling roller 130. The process chamber maintains the appropriate temperature and atmospheric composition (typically an inert atmosphere such as nitrogen) for the fabrication of the article.

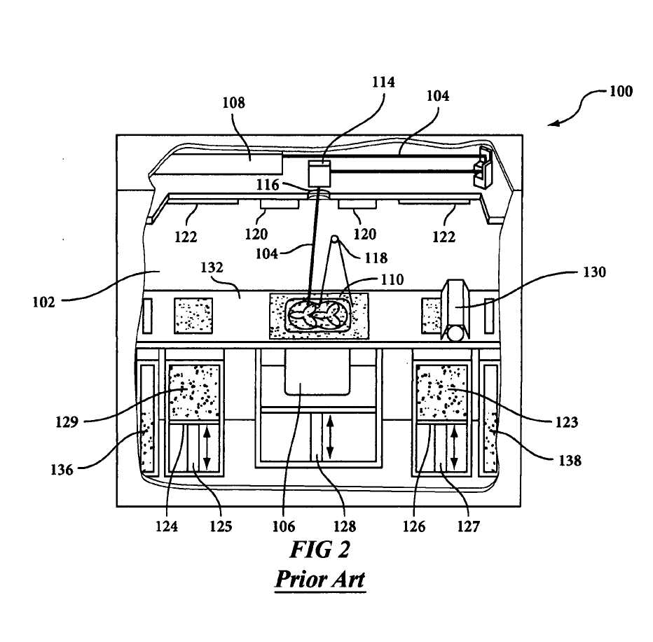

Operation of this conventional selective laser sintering system is shown in FIG. 2 in a front view of the process, shown generally as the numeral 100, with no doors shown for clarity. A laser beam 104 is generated by laser 108, and aimed at target area 110 by way of scanning system 114, generally including galvanometer-driven mirrors that deflect the laser beam. The laser and galvanometer systems are isolated from the hot chamber 102 by a laser window 116. The laser window 116 is situated within radiant heater elements 120 that heat the target area 110 of the part bed below. These heater elements 120 may be ring shaped (rectangular or circular) panels or radiant heater rods that surround the laser window. A temperature sensor 118 is part of a temperature feedback control loop that regulates power to heater elements 120. A control system provides control of the deflection of the laser beam is controlled in combination with modulation of laser 108 itself, to direct laser energy to those locations of the fusible powder layer corresponding to the cross-section of the article to be formed in that layer. Selective sintering of sequential layers within the layer cross sections eventually produces a part comprising a plurality of layers sintered together.

Two feed systems (124, 126) feed powder into the system by means of a push up piston system. A part bed 132 receives powder from the two feed pistons as follows: Feed system 126 first pushes up a measured amount of powder and a counter-rotating roller 130 acts as a spreading mechanism to spread the powder over the part bed in a uniform manner. The counter-rotating roller passes completely over the target area 110 and feed bed 124 and then dumps any residual powder into an overflow container 136. Positioned nearer the top of the chamber are radiant heater elements 122 that pre-heat the feed powder and a ring or rectangular shaped radiant heater element 120 for heating the part bed surface This element has a central opening which allows a laser beam to pass through the optical element 116. After a traverse of the counter-rotating roller across the system the laser selectively fuses the layer just dispensed and then the roller returns from the area of the overflow chute 136, the feed piston 124 pushes up a prescribed amount of powder and the roller dispenses powder over the target 110 in the opposite direction and proceeds to the other overflow 138 to drop residual powder. Before the roller begins each traverse of the system the center part bed piston 128 drops by the desired layer thickness to make room for additional powder.

The powder delivery system in system 100 includes feed pistons 124, 126, controlled by motors (not shown) to move upwardly and lift (when indexed) a volume of powder into chamber 102. Part piston 128 is controlled by a motor (not shown) to move downwardly below the floor of chamber 102 by a small amount, for example 0.125 mm, to define the thickness of each layer of powder to be processed. Roller 130 is a counter-rotating roller that translates powder from feed piston 126 onto target area 110. When traveling in either direction the roller carries any residual powder not deposited on the target area into overflow cartridges (136, 138) on either end of the chamber. Target area 110, for purposes of the description herein, refers to the top surface of heat-fusible powder (including portions previously sintered, if present) disposed above part piston 128; the sintered and unsintered powder disposed on part piston 128 will be referred to herein as part bed 132. System 100 of FIG. 2 also requires radiant heaters 122 over the feed pistons to pre-heat the powders to minimize any thermal shock as fresh powder is spread over the recently sintered and hot target area 110. This type of dual push up piston feed system with heating elements for both feed and part beds is implemented commercially in the Vanguard selective laser sintering system sold by 3D Systems, Inc. of Valencia, Calif.

Another known powder delivery system uses overhead hoppers to feed powder from above and either side of part bed 132, in front of a spreading mechanism such as a roller, wiper or scraper.

An aspect of this invention is the enhancing of flame retardance and mechanical properties of an industry standard SLS material by combining it with selected nanoparticles. The reinforcement of polymers using fillers, whether inorganic or organic, is common in the production of modern plastics. Polymeric nanocomposites (PNCS) (or polymer nanostructured materials) represent a radical alternative to conventional-filled polymers or polymer blends. In contrast to the conventional systems where the reinforcement is on the order of microns, discrete constituents on the order of a few nanometers (˜10,000 times finer than a human hair) exemplify PNCs. Uniform dispersion of these nanoscopically sized filler particles (or nanomaterials) produces ultra-large interfacial area per volume between the nanomaterial and host polymer. This immense internal interfacial area and the nanoscopic dimensions between nanomaterials fundamentally differentiate PNCs from traditional composites and filled plastics. Thus, new combinations of properties derived from the nanoscale structure of PNCs provide opportunities to circumvent traditional performance trade-offs associated with conventional reinforced plastics, epitomizing the promise of nano-engineered materials.

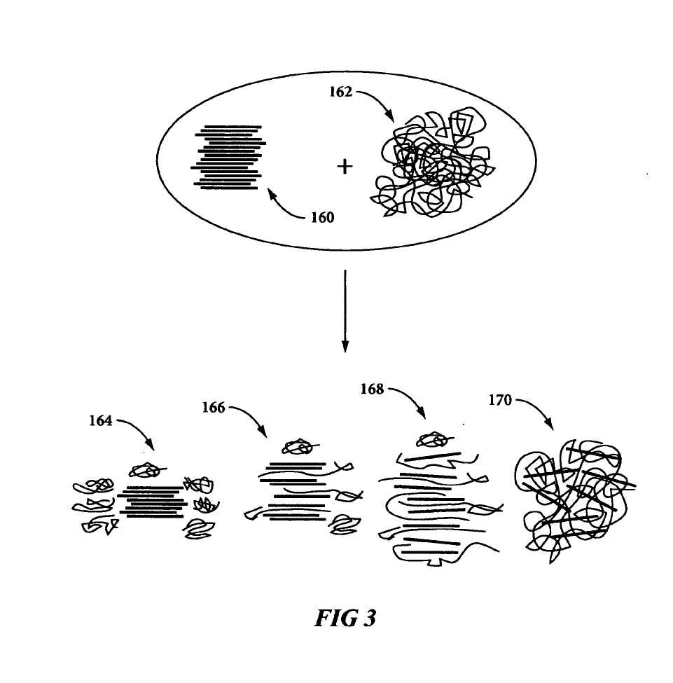

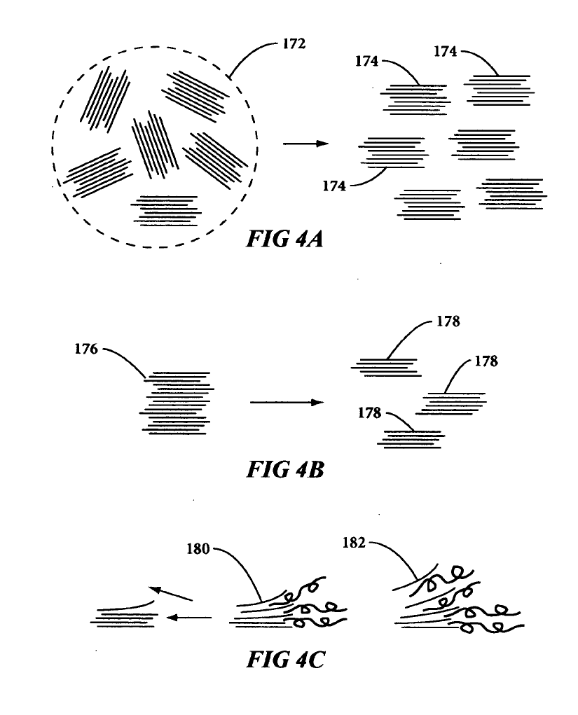

To achieve the very large interfacial area and nanoscopic dimensions between nanomaterials that distinguish PNC's from ordinary polymeric compounds requires new approaches for incorporating the particles into the polymer matrix. Methods for doing this are called exfoliation methods. Exfoliation is a process wherein packets of nanoclay platelets separate from one another in a plastic matrix. FIGS. 3 and 4, taken from an article by Fornes and Paul in Polimeros:Ciencia e Tecnologia (vol 13, n4, p. 212) illustrate the concept of exfoliation. In FIG. 3 platelets 160 (tactoids) of clay particles are intermixed with polymer chains 162, leading to a mixed state 164. An intercalant, which is an organic or semi-organic chemical capable of entering the montmorillonite clay gallery and bonding to the surface is added and leads to an intercalated state 166 in which a clay-chemical complex forms wherein the clay gallery spacing has increased leading to a disordered state 168, due to the process of surface modification. Under the proper conditions of temperature and shear, an intercalate is capable of fully exfoliating 170 in a resin matrix. The objective of the exfoliation method of PNC fabrication is to uniformly disperse and distribute the inorganic (initially comprised of aggregates of the nanomaterials) within the polymer. The final PNC structure results from the transformation of an initially microscopically heterogeneous system to a nanoscopically homogenous system. At least four approaches have been used to fabricate PNCs using exfoliation: (1) solution processing, (2) mesophase mediated processing, (3) in-situ polymerization, and (4) melt processing. Each methodology has advantages with respect to the processing steps required by the desired final form of the PNC (powder, film, paste, fiber, bulk monolith). Substantial research efforts have been done to address the fundamental challenge of providing general guidelines, including thermodynamic, kinetic, and rheological considerations, for morphology control using these fabrication processes. The earlier mentioned development of very effective in-situ polymerization methods by Toyota provided early interests in these applications but as mentioned previously does not provide cost effective application for laser sintering powders.

Nanocomposites have been formed using a variety of shear devices (e.g., extruders, mixers, ultrasonicators, etc.). Of these melt-processing techniques, twin-screw extrusion has proven to be most effective for the exfoliation and dispersion of silicate layers. Owing to the combination of shear and good polymer-organoclay affinity, twin-screw extrusion leads to composite properties comparable to those produced by in-situ techniques. A possible mechanistic explanation of the action of exfoliation in an extruder is shown in FIG. 4. The shearing action of the extruder leads to a breakup of large agglomerates 172 of nanocomposite clay particles into stacks 174. The shearing action of the extruder breaks these stacks 176 into smaller tactoids 178. Then the continued action of shear combined with diffusion of polymer chains between the bendable platelets leads to a peeling apart 180 of the tactoids, resulting eventually in a more homogeneous exfoliated structure 182. The advantages of forming nanocomposites by melt processing are quite appealing. The process is environmentally sound since no solvents are required. It shifts nanocomposite production downstream, thereby giving end-use manufacturers many degrees of freedom with regard to final product specifications (e.g., selection of polymer grade, choice of organoclay, level of reinforcement, etc.). At the same time, melt processing minimizes capital costs due to its compatibility with existing processes.

An aspect of the instant invention is the combination of this technology with the freeform fabrication (without molds) of parts to help meet the objectives of improved, high strength polymer powdered materials to manufacture “net shape” replacement parts by the SLS method. The SLS method is a pressureless process and can only be used with a limited suite of polymer systems. In particular materials that resolidify or recrystallize quickly after melting tend to exhibit an in-build curl that results in unacceptable performance in SLS. U.S. Pat. No. 5,648,450 discloses a number of the few polymer systems that have this property. These include nylons 11 (PA11), nylon 12 (PA12), polybutylene terephthalate (PBT); polypropylene (PP); and polyacetal (PA). Within the field of semi-crystalline polymer systems the dominant polymers in commercial use in SLS are nylon 11 (PA11) and nylon 12 (PA12). Interestingly few other polyamides work well in laser sintering. These two polyamides work effectively in lasers sintering because they recrystallize sufficiently slowly in the selective laser sintering process to eliminate any in-build curl. This type of crystalline response is sensitive however to how the polymer was manufactured and can be lost if the polymer is taken through significant melt-recrystallization cycles. Thus any treatment of these types of polymers to address flame retardance is impractical if the treatment destroys the crystalline response desired. It has now been found though that the aforementioned procedure of using a melt blend extrusion with low amounts (<7% by weight) of certain nanoparticles can achieve the required nanophase that results in significant improvements in flame retardance and higher heat deflection temperature while the relatively low level of nanoparticles required does not severely penalize other properties such as modulus, melt flow, and moisture resistance. This discovery is an aspect of the instant invention. It has never before been proven for the specialty powders that work effectively in laser sintering.

Although a number of different types of nano size particles can be used in this application and are anticipated by this invention three were used to demonstrate the concept. The nanoparticles were used, namely Southern Clay Products' montmorillonite (MMT) nanoclays, Degussa's nanaosilica, and Applied Sciences' carbon nanofibers (CNF). The focus of the work was the incorporation of these nanoparticles into nylon (polyamide) 11 (PA11) and nylon (polyamide) 12 (PA12) to form nylon (polyamide) 11 nanocomposite (PA11N) and a nylon (polyamide) 12 nanocomposite (PA12N). A 30 mm Werner Pfleidererer co-rotating twin-screw extruder was used and was configured for a wide variety of materials. Approximately 10 lbs of each formulation were produced and tested. The polymers were dried in a desiccant drier before compounding. Injection molded specimens of each blend were prepared and examined by WAXD and TEM. Examination of the TEM micrographs of the resulting nylon nanocomposites showed clear evidence of exfoliation of the nanoparticles in polymer was achieved. The resulting nanocomposite polymers were then cryogenically ground back to fine particles for use in laser sintering.

Polymer Nanoparticles Three types of nanoparticles have been demonstrated, namely Southern Clay Products' montmorillonite (MMT) nanoclays, Degussa's nanaosilica, and Applied Sciences' carbon nanofibers (CNF). These nanoparticles will reinforce the polymer in the nanoscale and will enhance the dimensional stability and mechanical properties of the polymer nanocomposites. To achieve the potential improvements it usually requires excellent dispersion and some degree of exfoliation (for nanoclay). These are shown to be dependent upon a combination of proper chemical treatment and optimized processing.

Nanoclays Achieving exfoliation of organomontmorillonite in various continuous phases is a function of the surface treatment of the MMT clays and the mixing efficiency of the dispersing protocol. Surface treatment of MMT is classically accomplished with the exchange of inorganic counterions, e.g., sodium, etc., with quaternary ammonium ions. Two MMT nanoclays including Southern Clay Products (a) Cloisite® 30B (a natural MMT modified with an organic modifier, MT2-tOT: methyl-tallow-bis-2-hydroxyethyl-quaternary ammonium at 90 meq/100 g) and (b) Cloisite® 93A (a natural MMT modified with an organic modifier M2HT: methyldihydrogenated tallow ammonium at 90 meq/100 g clay).

Nanosilica AEROSIL® is highly dispersed, amorphous, very pure silica that is produced by high-temperature hydrolysis of silicon tetrachloride in an oxyhydrogen gas flame. The primary particles are spherical and free of pores. The primary particles in the flame interact to develop aggregates that join together reversibly to form agglomerates. AEROSIL® 300 is a hydrophilic fumed silica with a specific surface of 300 m2/g manufactured by Degussa. It has an average particle size of 7 nm in diameter. AEROSIL® fumed silica for rheology control is widely used in silicone rubber, coatings, plastics, printing inks, adhesives, lubricants, creams, ointment, and in toothpaste.

Carbon Nanofibers (CNF) CNF are a form of vapor-grown carbon fiber, which is a discontinuous graphitic filament produced in the gas phase from the pyrolysis of hydrocarbons. In properties of physical size, performance improvement, and product cost, CNF complete a continuum bounded by carbon black, fullerenes, and single-wall to multi-wall carbon nanotubes on one end and continuous carbon fiber on the other end. PR-19-PS CNF was used in our study. The morphology of selective resin/nanoparticle systems were characterized using transmission electron microscopy (TEM) and scanning electron microscopy (SEM) analyses. These TEM images facilitated screening various formulations for desirable nano-level dispersion of the clay or nanosilica or CNF within the polymer. Desirable features included higher levels of clay exfoliation, nanodispersion of nanosilica, and uniform dispersion of CNF within the polymer.

The inventive concept was demonstrated by incorporating nanoparticles into nylon (polyamide) 11 (PA11) to form nylon (polyamide) 11 nanocomposite (PA11N). Different types of nanoparticles were melt blended with Atofina RILSAN® PA11 to form polyamide 11 nanocomposites (PA11N). The resulting nanocomposite structures we analyzed using wide-angle X-ray diffraction (WAXD), transmission electron microscopy (TEM), and scanning electron microscopy (SEM). The polymer nanocomposites were then both injection molded and laser sintered (after cryogenic grinding back into a powder) for physical, mechanical, flammability, and thermal properties testing. Flammability properties were measured using a cone calorimeter with a radiant flux of 50 kW/m2. Reductions in polymer flammability ranged from 18 to 60% without substantial losses in mechanical properties.

While the invention has been described above with references to specific embodiments, it is apparent that many changes, modifications and variations in the materials, arrangement of parts and steps can be made without departing from the inventive concept disclosed herein. Accordingly, the spirit and broad scope of the appended claims is intended to embrace all such changes, modifications and variations that may occur to one of skill in the art upon a reading of the disclosure.

1. A method of producing a flame retardant part comprising the steps of:
a. depositing a first portion of powder onto a target surface, said first portion of powder comprising a first material and a second material, said second material comprising nanoparticles;
b. scanning the aim of a directed energy beam over the target surface;
c. sintering a first layer of the first powder portion corresponding to a first cross-sectional region of the part by operating the beam when the aim of the beam is within boundaries defined by said first cross-sectional region;
d. depositing a second portion of powder onto the first sintered layer, said second portion of powder comprising a first material and a second material, said second material comprising nanoparticles;
e. scanning the aim of a directed energy beam over the first sintered layer;
f. sintering a second layer of the second powder portion corresponding to a second cross-sectional region of the part by operating the beam when the aim of the beam is within boundaries defined by said second cross-sectional region, including the substep of joining the first and second layers during the sintering of the second layer; and
g. depositing successive portions of powder onto the previous sintered layers and sintering each successive portion to produce successive sintered layers joined to a previous sintered layer and a part comprising a plurality of sintered layers.

2. The method of claim 1 wherein said nanoparticles are selected from the group consisting of montmorillonite nanoclays, nanaosilica, and carbon nanofibers.

3. The method of claim 1 wherein said first material is selected from the group consisting of nylon 11, nylon 12, polybutylene terephthalate; polypropylene; and polyacetal.

4. The method of claim 1 wherein said first material and said second material are combined using a polymer extrusion process.

5. The method of claim 4 wherein said polymer extrusion process is a twin screw extrusion process.

6. The method of claim 4 wherein said first and second material, after combination, is cryogenically ground into a powder.

7. A flame retardant part produced by the method of claim 1.

8. An apparatus for producing a flame retardant part comprising:
a. a scanning system for selectively emitting a directed energy beam;
b. a structure for providing a target area for producing the part;
c. a powder comprising a first material and a second material, said second material comprising nanoparticles;
d. a spreading mechanism for spreading said powder across said target area; and
e. a control system for deflecting the aim of the energy beam and for modulating the energy beam to selectively sinter within defined boundaries a layer of powder dispensed in said target area, the control system being operable to effect selective sintering of sequential layers of powder within respective defined boundaries to produce a part comprising a plurality of layers sintered together.

9. The apparatus of claim 8 wherein said nanoparticles are selected from the group consisting of montmorillonite nanoclays, nanaosilica, and carbon nanofibers.

10. The apparatus of claim 8 wherein said first material is selected from the group consisting of nylon 11, nylon 12, polybutylene terephthalate; polypropylene; and polyacetal.

11. The apparatus of claim 8 wherein said spreading mechanism is a rotating roller.

12. The apparatus of claim 8 wherein said spreading mechanism is a wiper.

13. The apparatus of claim 8 wherein said spreading mechanism is a scraper.

14. A flame retardant part produced by the apparatus of claim 8.
